(19) United States
(12) Patent Application Publication
(10) Pub. No.: US 2022/0343421 A1
(43) Pub. Date: Oct. 27, 2022

(54) OPTIMIZED MODEL FOR REDUCING LEASE LIABILITY

(71) Applicants: Craig H. Lussi, Gibson Island, MD (US); Hunter M. Lussi, Gibson Island, MD (US); Tyler T. Lussi, Gibson Island, MD (US); Morgan M. Lussi, Gibson Island, MD (US)

(72) Inventors: Craig H. Lussi, Gibson Island, MD (US); Hunter M. Lussi, Gibson Island, MD (US); Tyler T. Lussi, Gibson Island, MD (US); Morgan M. Lussi, Gibson Island, MD (US)

(21) Appl. No.: 17/568,403

(22) Filed: Jan. 4, 2022

Related U.S. Application Data
(60) Provisional application No. 63/133,475, filed on Jan. 4, 2021.

(51) Int. Cl. G06Q 40/02; G06Q 30/06

(52) U.S. Cl. CPC G06Q 40/025; G06Q 30/06

(57) ABSTRACT

Embodiments are directed to balance sheet operating expense lease liability reduction systems and methods that provide flexibility to tenants and securitization to landlords. In an embodiment a system includes a landlord of an asset for a fixed lease term willing to provide a rolling termination option to tenants. The system also includes a tenant (lessee) desiring to lease an asset (office, retail or residential space or airplanes, trucks, etc.) for a fixed lease term but desiring to have the flexibility of only having +/−25% of the lease liability on their balance sheet. The system further includes a lease with a rolling termination lease clause, which may include the requirement for a letter of credit in the amount of the termination payment and which accomplishes the landlord's and tenant's objectives.

### FIELD

The present disclosure relates to a method for reducing lease liability, increasing lease term flexibility, and stabilizing real estate values and/or the values of any asset(s) that derives its value from annual lease payments. The present disclosure relates to leases such as office space leases, retail space leases, residential space leases, ground leases, airplanes leases, car leases, truck leases, copy machine leases, equipment leases, and leases of assets of other kinds.

### BACKGROUND

Leases for the use of assets such as office space for a fixed annual rent amount (operating rent), usually paid on a monthly basis over a set term of years, must be accounted for by placing the entire lease cost of the fixed lease term on a corporation's balance sheet as a liability offset with an equal amount described as a right to use the assets by the corporation/lessee. This large lease cost, which is listed as a liability on a corporation's balance sheet, is an inflexible fixed cost with an offsetting right to use the office space.

### BRIEF DESCRIPTION OF THE DRAWINGS

The accompanying drawings, which are incorporated herein and form part of the specification, illustrate aspects and, together with the description, further serve to explain the principles of the aspects and to enable a person skilled in the relevant art(s) to make and use the aspects.

FIG. 1 is an example computer system useful for implementing various embodiments.

### DETAILED DESCRIPTION

Embodiments of the present invention(s) will now be described in detail with reference to aspects thereof as illustrated in the accompanying drawings. References to “one aspect,” “an aspect,” “an exemplary aspect,” etc., indicate that the aspect described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it is submitted that it is within the knowledge of one skilled in the art to affect such feature, structure, or characteristic in connection with other aspects whether or not explicitly described.

Embodiments described herein illustrate the Balance Sheet Friendly Lease, which allows corporations and nonprofits (in particular, organizations who utilize accrual accounting) to reduce the amount that must be placed on their balance sheets. For example, the rolling, evergreen “anytime” lease termination right for some or all of the space (or asset) leased, solely exercisable by the lessee (tenant) for a fixed termination amount (which fixed amount declines over the term of the lease), contained in the Balance Sheet Friendly Lease™ may be twenty-five percent (25%) of the remaining total lease liability, which saves the corporations and nonprofits lessees (tenants) seventy-five percent (75%) of their operating rent liability on their balance sheets (operating rent is the second largest annual expense after salaries for most corporations and nonprofits). In some embodiments, these percentages and/or amounts of space (or asset allocation) leased may be modified by agreement of the lessor (landlord) and lessee (tenant). An example rolling termination fee schedule is provided below. For purposes of illustration, the example assumes a lease of ten (10) years with an annual fixed rent of $1,000,000 (note that this example is used for illustrative purposes only, as rents would typically be calculated with increasing or decreasing annual amounts throughout the term of the lease to account for, e.g., inflation or anticipated property value change). The specific language and amounts provided in the example are not intended to be limiting and are merely intended to illustrate terms effecting a rolling termination option.

As a condition to a notice of termination (“Termination Notice”) being effective, Tenant shall deliver to Landlord by not later than thirty (30) days prior to the termination date (“Termination Date”) a termination fee (Termination Fee”), payable by certified check or bank check or wired funds, in accordance with the following schedule:

| Lease Year | Termination Fee |
|---|---|
| 1 | $2,500,000.00 |
| 2 | $2,225,000.00 |
| 3 | $2,000,000.00 |
| 4 | $1,750,000.00 |
| 5 | $1,500,000.00 |
| 6 | $1,250,000.00 |
| 7 | $1,000,000.00 |
| 8 | $750,000.00 |
| 9 | $500,000.00 |
| 10 | $250,000.00 |

This flexibility for corporations and nonprofits to be able to have long fixed-lease terms, but only account, report, and be bound by twenty-five percent (25%) of their remaining total lease liability, can dramatically increase their profitability, asset value, and stock value without negatively impacting the value of landlords' (lessors') assets. In various embodiments, the Balance Sheet Friendly Lease™ techniques may be incorporated into all types of leases for assets, such as office, retail and residential leases, airplane and airplane fleet leases, and truck and truck fleet leases, copy machine leases, equipment leases, and leases of assets of other kinds.

Lessors, also known in the field of real estate as landlords, and their lenders, investors, and appraisers, value leased real estate assets, such as office buildings. These valuations may be based on the capitalization (dividing by a particular rate of return) of the net income of the annual lease payments over the term of the years remaining on the lease (the income approach), or based on other valuation methods, such as the replacement cost method (the cost to replace/recreate the asset) and sales comparison method (the value for which similar assets have sold/traded).

Historically, lessors (owners), lenders, and investors have claimed that any lease termination right held by office, retail, and/or residential tenants will reduce the asset (e.g., building) value and put the lessor's loan (if any) and/or the investors' equity in jeopardy. This is allegedly because the lessor may not be able to pay the lenders' loan(s) and/or the investors' equity returns without the guarantee of long-term annual lease payments from office, retail, and/or residential tenants who have lease termination options. But this is a misconception because hotels, for example, which are highly valued real estate assets with loans and/or equity investors, are supported by leases that are as short as one (1) day, and shared office leases (license agreements) in office buildings can be as short as a few hours and rarely exceeding one (1) year. And lessors, with lenders and/or equity investors permission, have themselves leased space in their assets to operate shared office businesses. Additionally, other than full building user build-to-suit office and/or retail buildings, most new office, retail, residential and/or hotel buildings utilizing loans and/or equity investors have large portions, if not all, of their available space vacant upon completion of construction. Owners of these buildings often also have built into their lease up proformas eighteen (18) months to thirty (30) months of operating expenses for the building and loan interest payments and/or investor equity investment returns. Further, prudent lessors (owners) may escrow a portion of each tenant's lease payments to cover the cost of operating costs, loan interest payments, and/or equity investors' return payments during vacancy for when the tenant's lease expires, and the tenant may choose to relocate and/or request concessions to sign a lease extension. This amount of escrowed rent for when a tenant's lease expires is rarely more than the original eighteen (18) months to thirty (30) months of operating costs, loan interest payments, and/or equity investors' return payments for the building.

Therefore, rolling lease termination options have little to no negative impact on the operations of office, retail, residential, and/or hotel buildings, provided the termination payments are sufficient to cover the operating expenses for the building, loan interest carry, and/or investor equity investment return payments (when combined with the owner's escrows for operating costs for the building, loan interest carry, and/or investor equity investment returns—owner's escrows increase over the term of a tenant's lease and termination payments decrease). In fact, lease termination payments securitized by letters of credit in the same amounts as the termination payments provide landlords (owners), lenders, and/or investors more security than relying on the ability of good credit tenants to pay the rent in all types of situations. This has been proven, for example, by the 2020 global pandemic (the second worst global pandemic lasting 12-18 months as compared to the 1918 Spanish flu pandemic, which lasted 3 years) because of the speed with which vaccines can be created and dispersed in 2020. The termination payment-letter of credit for a particular lease would span a future pandemic to the benefit of landlords (owners), lenders, and/or investors.

In an embodiment, an equitable percentage of the rent to be paid as a rolling termination payment by a tenant to the landlord (owner) during the lease term in the form of a letter of credit may be 25% of the total remaining lease payments. In other words, a tenant who signs a ten (10) year lease could provide the landlord (owner) a letter of credit from a bank approved by the landlord (owner) for 2.5 years of rent and terminate at any time during the term of the lease with some reasonable notice period (three (3) to six (6) months). The letter of credit guarantees the landlord (owner) will actually receive the termination payment and allows the tenant to record the annually decreasing termination payment on their balance sheet as their total lease liability. In this example, this approximate 75% savings in lease liability provides the tenant a huge reduction in their liabilities as leasing costs are often the second largest costs (liabilities) after salaries for most corporations and nonprofits, as mentioned previously. In an embodiment, tenants who utilize the Balance Sheet Friendly Lease™ may gain the additional benefit by requesting the letter of credit from a bank who has a relationship with a trust company or investment bank who can still invest the funds that secure the letter of credit, so the tenant does not suffer any lost investment returns to gain the 75% reduction in their lease liability.

In an embodiment, tenants who are banks and/or investment banks and who utilize the Balance Sheet Friendly Lease™ may choose to loan lease transaction costs (such as tenant improvement monies for tenant improvements, free rent, brokerage fees, legal fees, architectural fees, engineering costs, moving costs, equipment and furnishings costs, furniture costs, etc.) at any interest rate they choose to the landlord, over the lease term, reducing their annual rent expense by the amount of the amortization of the amount loaned and reducing the termination payment (and letter of credit obligation amount). This could reduce a rolling termination payment (and letter of credit in the same amount) required by a tenant to the landlord (owner) during the lease term from 25% of the total remaining lease payments, as in the above-described embodiments, to zero, if the amount of the lease transaction costs loaned exceeds 25%. In most cases, transaction costs range from 10% to 20% of the total remaining lease payments, so the bank and/or investment bank tenant who chooses to loan their transaction costs to the landlord (owner) could reduce not only their annual rent payments by the amount of the amortization of the amount loaned but also their balance sheet lease liability down to 15% to 5% (respectively) of the total lease liability (and the loan to the landlord [owner] would be listed in the balance sheet notes of the tenant as a note receivable—an asset). The annual rent in the lease for an income producing asset (building) valuation purposes would still be the landlord's proforma rent and produce the landlord's (owner's) lender's required net operating income and lending coverage ratios, but because the source of the transaction cost loan would be from the tenant and not the landlord's (owner's) lender, the negotiation of the transaction costs could be much more flexible, easier facilitated, and tailored to the tenant's needs.

Landlords (owners), lenders, and/or investors who are versed in the Balance Sheet Friendly Lease™ method will realize that if a tenant uses the 25% termination penalty payment (as in the above-described embodiments) as a way of negotiating and/or terminating the tenant's lease to relocate to another landlord's building, the tenant (unless they have the license to use the Balance Sheet Friendly Lease™ method at their relocation building) will actually be increasing their lease liability (expense) from 25% to 125% on their balance sheet, as the tenant will be obligated to pay the 25% (secured by the letter of credit for the 25%, which the landlord of the building the tenant is occupying is permitted to cash in by its terms) and 100% of the new lease liability.

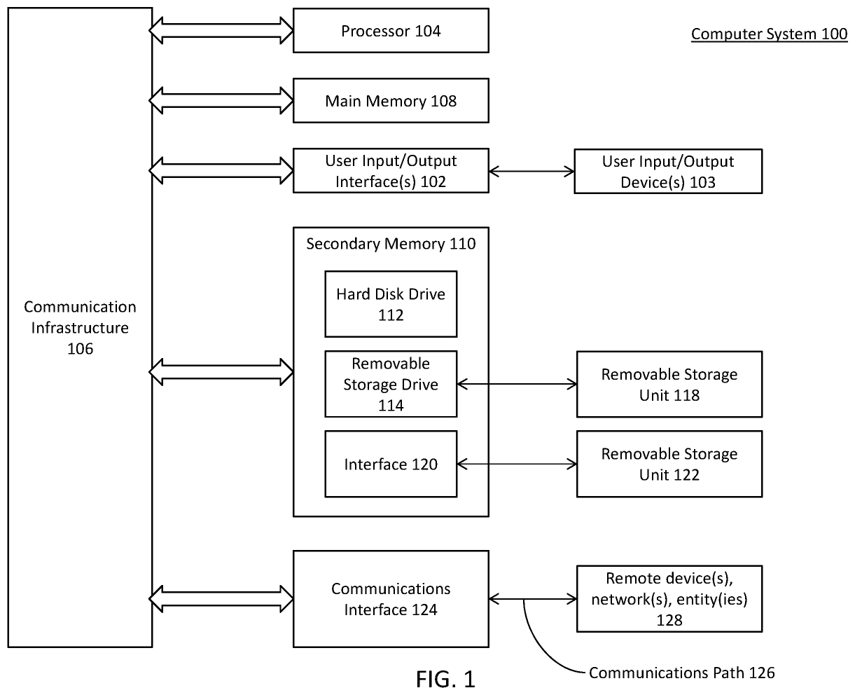

Various embodiments involving the Balance Sheet Friendly Lease™ may be implemented, for example, using one or more computer systems, such as computer system 100 shown in FIG. 1. Computer system 100 can be any computer capable of performing the functions described herein, such as determining lease schedules and fees.

Computer system 100 includes one or more processors (also called central processing units, or CPUs), such as a processor 104. Processor 104 is connected to a communication infrastructure or bus 106. One or more processors 104 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 100 also includes user input/output device(s) 103, such as monitors, keyboards, pointing devices, etc., that communicate with communication infrastructure 106 through user input/output interface(s) 102.

Computer system 100 also includes a main or primary memory 108, such as random access memory (RAM). Main memory 108 may include one or more levels of cache. Main memory 108 has stored therein control logic (i.e., computer software) and/or data.

Computer system 100 may also include one or more secondary storage devices or memory 110. Secondary memory 110 may include, for example, a hard disk drive 112 and/or a removable storage device or drive 114. Removable storage drive 114 may be a floppy disk drive, a magnetic tape drive, a compact disk drive, an optical storage device, tape backup device, and/or any other storage device/drive.

Removable storage drive 114 may interact with a removable storage unit 118. Removable storage unit 118 includes a computer usable or readable storage device having stored thereon computer software (control logic) and/or data. Removable storage unit 118 may be a floppy disk, magnetic tape, compact disk, DVD, optical storage disk, and/any other computer data storage device. Removable storage drive 114 reads from and/or writes to removable storage unit 118 in a well-known manner.

According to an exemplary embodiment, secondary memory 110 may include other means, instrumentalities or other approaches for allowing computer programs and/or other instructions and/or data to be accessed by computer system 100. Such means, instrumentalities or other approaches may include, for example, a removable storage unit 122 and an interface 120. Examples of the removable storage unit 122 and the interface 120 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 100 may further include a communication or network interface 124. Communication interface 124 enables computer system 100 to communicate and interact with any combination of remote devices, remote networks, remote entities, etc. (individually and collectively referenced by reference number 128). For example, communication interface 124 may allow computer system 100 to communicate with remote devices 128 over communications path 126, which may be wired and/or wireless, and which may include any combination of LANs, WANs, the Internet, etc. Control logic and/or data may be transmitted to and from computer system 100 via communication path 126.

In an embodiment, a tangible apparatus or article of manufacture comprising a tangible computer useable or readable medium having control logic (software) stored thereon is also referred to herein as a computer program product or program storage device. This includes, but is not limited to, computer system 100, main memory 108, secondary memory 110, and removable storage units 118 and 122, as well as tangible articles of manufacture embodying any combination of the foregoing. Such control logic, when executed by one or more data processing devices (such as computer system 100), causes such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 1. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific aspects will so fully reveal the general nature of the invention that others can, by applying knowledge within the skill of the art, readily modify and/or adapt for various applications such specific aspects, without undue experimentation, without departing from the general concept of the present invention. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

What is claimed is:

1. A balance sheet operating expense lease liability reduction system that provides flexibility to tenants and securitization to landlords comprising:
a landlord (owner and or lessor) of an asset for a fixed lease term willing to provide a rolling termination option to tenants as is normal in hotel stays and shared office arrangements, but not provided in office, retail and apartment space leases, airplane leases, truck leases, etc. as landlords (owners) and lenders and investors are concerned rolling termination options will devalue their assets (buildings);
a tenant (lessee) desiring to lease an asset (office, retail or residential space or airplanes, trucks, etc.) for a fixed lease term but desiring to have the flexibility of only having +/−25% of the lease liability on their balance sheet; and
a lease with a rolling termination lease clause which may include the requirement for a letter of credit in the amount of the termination payment and which accomplishes the landlord's and tenant's objectives and, in addition, allows the tenant to lend the landlord (owner) the transaction costs without reducing the asset value, but further reducing the lease liability on the tenant's balance sheet, potentially to zero.
